(19) United States
(12) Patent Application Publication
(10) Pub. No.: US 2025/0068139 A1
(43) Pub. Date: Feb. 27, 2025

(54) METHOD FOR POSITIONING MOVABLE HEAD, PROGRAM MEDIUM, COMPUTER NUMERICAL CONTROL MACHINE AND MACHINING SYSTEM

(71) Applicant: MAKEBLOCK TXZW CO., LTD., Guangzhou (CN)

(72) Inventor: Huan LI, Guangzhou (CN)

(21) Appl. No.: 18/949,176

(22) Filed: Nov. 15, 2024

Related U.S. Application Data
(63) Continuation-in-part of application No. PCT/CN2024/102300, filed on Jun. 28, 2024.

(30) Foreign Application Priority Data
Jun. 28, 2023 (CN) 202310782970.0
Jun. 14, 2024 (CN) 202410767787.8

(51) Int. Cl. G05B 19/402

(52) U.S. Cl. CPC G05B 19/402; G05B 2219/45165

(57) ABSTRACT

A method for positioning a movable head is provided, the method includes: displaying a marking point on a target interface in response to a request for obtaining position information of the movable head; the marking point characterizes a coordinate position of the movable head mapped to the target interface; and making the marking point displace on the target interface correspondingly when the movable head is displaced, to make the marking point fall on a machining element input on the target interface.

### CROSS-REFERENCE TO RELATED APPLICATIONS

This application is a continuation in part of International Application No. PCT/CN2024/102300, filed on Jun. 28, 2024, which claims priority to Chinese Application No. 202310782970.0, filed on Jun. 28, 2023, and Chinese Application No. 202410767787.8, filed on Jun. 14, 2024, the entire disclosures of which are hereby incorporated herein by reference.

### TECHNICAL FIELD

The present disclosure belongs to the field of laser machining technology, and specifically relates to a method for positioning a movable head, computer program medium, computer numerical control machine and machining system.

### BACKGROUND

When machining the material to be machined, the position of the laser head on the material to be machined is usually recognized with the naked eye, and the laser head is controlled to machine by the software. When a higher precision is required for the machining position, it is difficult for the user to clearly know the position of the laser head, making it difficult to realize high-precision positioning.

### SUMMARY

There are provided a method, apparatus, device and computer program medium for positioning a movable head according to embodiments of the present disclosure. The technical solution is as below:

According to a first aspect of embodiments of the present disclosure, there is provided a method for positioning a movable head, the movable head is configured to emit a laser, the method includes:
displaying a marking point on a target interface in response to a request for obtaining position information of the movable head; the marking point characterizes a coordinate position of the movable head mapped to the target interface; and making the marking point displace on the target interface correspondingly when the movable head is displaced, to make the marking point fall on a machining element input on the target interface.

In an embodiment of the present disclosure, before displaying the marking point on the target interface, the method further includes: obtaining an offset parameter of the movable head; and adjusting the position information of the movable head based on the offset parameter to determine a display position of the marking point on the target interface.

In an embodiment of the present disclosure, after displaying the marking point on the target interface, the method further includes: determining at least one machining position contained in the machining element in response to the machining element input by a user on the target interface; and aligning one of the at least one machining position with the marking point, to make the marking point fall on the machining element input on the target interface.

In an embodiment of the present disclosure, before the marking point falls on the machining element input on the target interface, the method further includes: determining a position of the movable head in a machining plane of the computer numerical control machine based on light spots emitted by the movable head.

In an embodiment of the present disclosure, the method further includes: determining a machining region on the material to be machined; mapping position information of the machining region to the target interface to obtain a corresponding machining region on the target interface; and aligning an input machining element with the corresponding machining region range on the target interface, to make the input machining element be located within the corresponding machining region range on the target interface.

In an embodiment of the present disclosure, after the marking point falls on the input machining element on the target interface, the method further includes: receiving a laser machining request; and controlling the movable head to machine along a target machining path in response to the laser machining request.

In an embodiment of the present disclosure, the making marking point displace on the target interface correspondingly when the movable head is displaced, the method further includes: making the marking point displace on the target interface correspondingly at preset time intervals when the movable head is displaced.

According to a second aspect of embodiments of the present disclosure, the apparatus is provided with the movable head, and the movable head is configured to eject a laser, the apparatus includes: a position information mapper, configured to display a marking point on a target interface in response to a request for obtaining position information of the movable head; the marking point characterizes a coordinate position of the movable head mapped to the target interface; and a locator, configured to make the marking point displace on the target interface correspondingly when the movable head is displaced, to make the marking point fall on a machining element input on the target interface.

According to a third aspect of embodiments of the present disclosure, there is provided a device for positioning a movable head, which includes: a memory storing computer readable instructions; and a processor, reading the computer-readable instructions stored in the memory to perform the method as mentioned above.

According to a fourth aspect of embodiments of the present disclosure, there is provided a computer program medium, on which computer-readable instructions are stored, the computer-readable instructions, when executed by a processor of a computer, cause the computer to perform the method as mentioned above.

According to a fifth aspect of embodiments of the present disclosure, there is provided a computer numerical control machine, which includes: a slide rail; a movable head, slidably provided on the slide rail; a communication component, for receiving a marking point obtained by the method as mentioned above; and a controller, for controlling a movement of the movable head on the slide rail to machine a surface of machining material based on the marking point.

According to a sixth aspect of embodiments of the present disclosure, there is provided a machining system, which includes:
a computer numerical control machine, including a communication component, a controller, a slide rail and a movable head, wherein the movable head is slidably provided on the slide rail;
a machining control device in communication with the computer numerical control machine; the machining control device is configured to execute a method for positioning a movable head, the movable head is configured to emit a laser,
the method includes:
displaying a marking point on a target interface in response to a request for obtaining position information of the movable head; wherein the marking point characterizes a coordinate position of the movable head mapped to the target interface; and
making the marking point displace on the target interface correspondingly when the movable head is displaced, to make the marking point fall on a machining element input on the target interface.

Other features and advantages of the present disclosure will become apparent through the following detailed description, or will be learned in member through the practice of the present disclosure.

It should be understood that the above general description and the detailed description that follows are merely exemplary and do not limit the present disclosure.

### BRIEF DESCRIPTION OF THE DRAWINGS

The foregoing and other objects, features, and advantages of the present disclosure will become more apparent by describing in detail exemplary embodiments thereof with reference to the accompanying drawings.

FIG. 1 is an architecture diagram of a system to which a method for positioning a movable head is applied according to an embodiment of the present disclosure.

FIG. 2 is a flowchart of a method for positioning a movable head according to an embodiment of the present disclosure.

FIG. 3 is a flowchart of the method for positioning the moveable head according to another embodiment of the present disclosure.

FIG. 4 is a flowchart of the method for positioning the moveable head according to another embodiment of the present disclosure.

FIG. 5 is a flowchart of the method for positioning the moveable head according to another embodiment of the present disclosure.

FIG. 6 is a flowchart of the method for positioning the moveable head according to another embodiment of the present disclosure.

FIG. 7 is a flowchart of positioning the moveable head according to an embodiment of the present disclosure.

FIG. 8 is a hardware structure diagram of the computer numerical control machine according to an embodiment of the present disclosure.

FIG. 9 is a hardware structure diagram of the machining system according to an embodiment of the present disclosure.

FIG. 10 is a block diagram of an apparatus for positioning a movable head according to an embodiment of the present disclosure.

FIG. 11 is a hardware structure view of the device for positioning a moveable head according to an embodiment of the present disclosure.

### DETAILED DESCRIPTION OF THE EMBODIMENTS

Embodiments will now be described more fully with reference to the accompanying drawings. However, the embodiments can be implemented in a variety of forms and should not be construed as limitation to the examples set forth herein; rather, the provision of these embodiments allows for the description of the present disclosure to be more comprehensive and complete and conveys the idea of embodiments in a comprehensive manner to those skilled in the art. The accompanying drawings are only schematic illustrations of the present disclosure and are not necessarily to scale. Identical accompanying symbols in the drawings indicate identical or similar portions, and thus repetitive descriptions of them will be omitted.

In addition, the features, structures, or characteristics described may be combined in one or more embodiments in any suitable manner. In the following description, many specific details are provided thereby giving a full understanding of the embodiments of the present disclosure. However, those skilled in the art will realize that it is possible to practice the technical embodiments of the present disclosure and omit one or more of the particular details, or that other methods, groups of elements, steps, etc. may be employed. In other cases, the publicly known structures, methods, implementations, or operations are not shown or described in detail to avoid overshadowing and obscuring aspects of the present disclosure.

The flowcharts shown in the accompanying drawings are merely exemplary illustrations and are not required to include all elements and operations/steps, nor are they required to be performed in the order depicted. For example, some operations/steps may also be decomposed, while others may be combined or partially combined, and thus the order in which they are actually performed is likely to change depending on the actual situation.

Some of the block diagrams shown in the accompanying drawings are functional entities that do not necessarily have to correspond to physically or logically separate entities. It is possible to implement these functional entities in software form, or to implement them in one or more hardware modules or integrated circuits, or to implement them in different networks and/or processor devices and/or microcontroller devices.

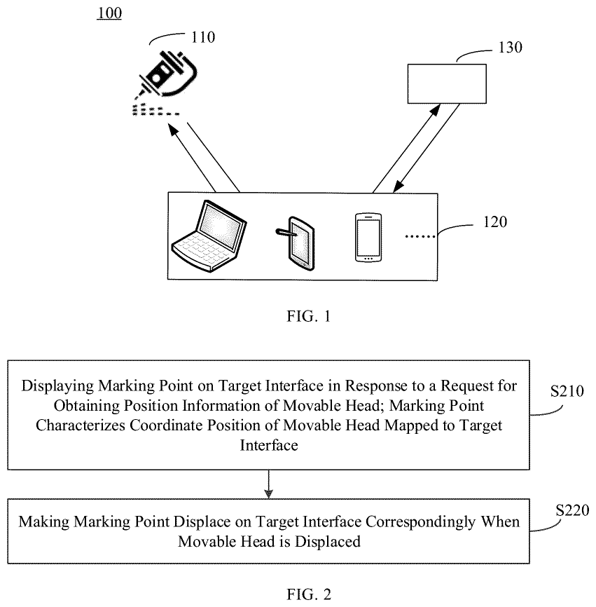

Referring to FIG. 1, FIG. 1 is a schematic diagram of an architecture applied by embodiments of the present disclosure. The architecture 100 may include: a moveable head 110, a communication medium 120, and a software 130. The moveable head is a mechanical module included in the machining device and is not equivalent to the machining device, and the moveable head may include a laser head, a knife cutter head, a plasma cutter head, a water pistol head, a drill, a pen head, etc., and is not uniquely limited herein. The communication medium 120 may be a device such as a walkie-talkie, a cell phone, a tablet computer, and a mobile internet device that supports at least data communication via the 3rd generation partnership project (3GPP) protocol. The communication medium 120 is provided with a software 130, through which a target interface can be presented. The movable head 110 and the communication medium 120 may be connected to each other via a wireless communication link, thereby enabling wireless data communication interactions, or a wired communication link or a fiber optic cable, etc., which is not limited in the present disclosure herein.

It should be understood that the number of communication mediums 120 in FIG. 1 is merely illustrative. There may be any number of communication mediums 120 as needed for implementation.

Some technical embodiments of the present disclosure may be concretely implemented based on an architecture shown in FIG. 1 or a morphing architecture thereof.

Referring to FIG. 2, FIG. 2 is a flowchart of a method for positioning a movable head according to an embodiment of the present disclosure. The method may be applicable to the architecture shown in FIG. 1, for example, may be specifically performed by the communication medium 120. Of course, the method may also be applicable to other architectures, which is not limited in this embodiment.

As shown in FIG. 2, the method includes:

Step S210, displaying a marking point on a target interface in response to a request for obtaining position information of the movable head; the marking point characterizes a coordinate position of the movable head mapped to the target interface; and

Step S220, making the marking point displace on the target interface correspondingly when the movable head is displaced, to make the marking point fall on a machining element input on the target interface.

These two steps are described in detail below, respectively.

It should be noted that a first coordinate system is pre-established on a machining plane of the computer numerical control machine, and the material to be machined has been placed on the machining plane before the implementation of the embodiments of the present disclosure.

Taking a communication medium as the execution body of the method provided in the present embodiment for an exemplary description, in step S210, the request for obtaining the position information of the movable head may be issued by the user controlling software or may be automatically generated by the software. When the request for obtaining the position information of the movable head indicated by the software is detected, the request for obtaining the position information of the movable head may be responded to in order to obtain the position information of the movable head.

In one embodiment of the present disclosure, the request for obtaining the position information of the movable head may be sent by the software, and is automatically generated, such that obtaining the position information of the movable head is more conveniently.

In another embodiment of the present disclosure, a switch button is provided on the target interface, and the user can send the request for obtaining the position information of the movable head by clicking “on” in the switch button.

In another embodiment of the present disclosure, an on button and an off button are provided on the target interface, and the user can send the request for obtaining the position information of the movable head by clicking the on button.

Since the first coordinate system is pre-established in the machining plane of the computer numerical control machine, the horizontal and vertical coordinates of the movable head in the first coordinate system can be obtained. The position information of the movable head includes the horizontal and vertical coordinates of the light spot emitted by the movable head in the first coordinate system. The target interface may be an operation interface that can only be operated, or a display interface that can only display, or an interface that can both display and be operated, which is not limited in the present disclosure herein. The marking point is a light point displayed by mapping the coordinate position of the movable head to the target interface. An encoder mounted on the movable head can obtain the coordinate position of the movable head, and map the coordinate position of the movable head to the target interface, thereby obtaining the marking point on the target interface corresponding to the coordinate position of the movable head.

In another embodiment, similarly, a second coordinate system is established on the target interface, and the second coordinate system can be established by selecting the upper-left corner, the lower-right corner, or a centered position as an origin, which is not limited in the present disclosure. After the second coordinate system is established, the position information of the movable head is converted into electrical signals and the electrical signals are uploaded to the software, which converts the uploaded electrical signals into coordinate positions in the second coordinate system, i.e., horizontal coordinates and vertical coordinates in the second coordinate system. After the horizontal and vertical coordinates of the position information of the movable head are determined in the second coordinate system, the marking point is displayed at the coordinate position on the target interface, so as to obtain the marking point on the target interface corresponding to the coordinate position of the movable head, so that the current position of the movable head can be clearly displayed on the target interface.

As can be seen from the above, by establishing the second coordinate system on the target interface, the embodiment of the present disclosure enables the user to clearly know the specific position where the marking point is located, which facilitates the subsequent alignment and adjustment operations, thereby enhancing the user experience.

It should be noted that the second coordinate system can be established in a different way from the first coordinate system, for example, the first coordinate system is established with the upper left corner of the machining plane of the computer numerical control machine as the origin, and the second coordinate system is established with the centered position of the target interface as the origin; the second coordinate system can also be established in the same way as the first coordinate system, i.e., the first coordinate system is mapped to the target interface to generate the second coordinate system, such that the origin in the first coordinate system and the origin in the second coordinate system coincide and match.

Accordingly, the present embodiment does not limit the real-time coordinate position of the movable head in the first coordinate system to be identical to the coordinate of the marking point corresponding to the movable head in the second coordinate system. It can be understood that if the real-time coordinate position of the movable head obtained by the movable head emitting the light point in the first coordinate system are A (a, b), the coordinate position B of the marking point obtained by mapping the coordinate A to the target interface may be (a+3, b+4), (a, b), (2a, 3b), or other coordinates. Specifically for example, when the offset parameter of the movable head is not considered, if the first coordinate system and the second coordinate system are established in the same way, the coordinate position B of the marking point should also be (a, b). If two coordinate systems are established in different ways, the coordinate position B of the marking point are determined by the establishment way of the second coordinate system. When the offset parameter is considered, if the first coordinate system and the second coordinate system are established in the same way, the coordinate position B of the marking point are determined by the offset parameter. If the first coordinate system and the second coordinate system are established in different ways, the coordinate position B of the marking point are determined by the establishment way of the second coordinate system and the offset parameter together. It is understood that the offset parameters of the movable head include a tilt angle, an offset direction, a focal length, etc.

In step S220, it is to be understood that since the marking point characterizes a coordinate position of the movable head mapped to the target interface, thus when the movable head is displaced, the marking point will also be correspondingly displaced on the target interface. Exemplarily, if the movable head is displaced by 5 cm to the left, the marking point is also displaced by 5 cm to the left, and if the movable head is displaced by 10 cm forward, the marking point is also displaced by 10 cm forward.

The machining element can be input by the user on the target interface according to the desired machining effect. The machining elements can be regular patterns such as polygons, circles, etc., and irregular patterns, such as irregular figures, scenery, etc., The machining elements can also be vector or bitmap. The vector, also known as vector map, is an image described by a series of geometric shapes (such as lines, curves, polygons, etc.) and can be enlarged or zoomed without distortion. The bitmap, also known as bitmap graphics, is an image simulated by a number of pixels, each pixel is described by a color value.

As a result, the position of the movable head is clearly and intuitively known to the user by the displayed marking point, which facilitates the user to adjust the position of the movable head, and when the user adjusts the position of the movable head to make the marking point fall on the input machining element, high-precision positioning of the movable head can be realized.

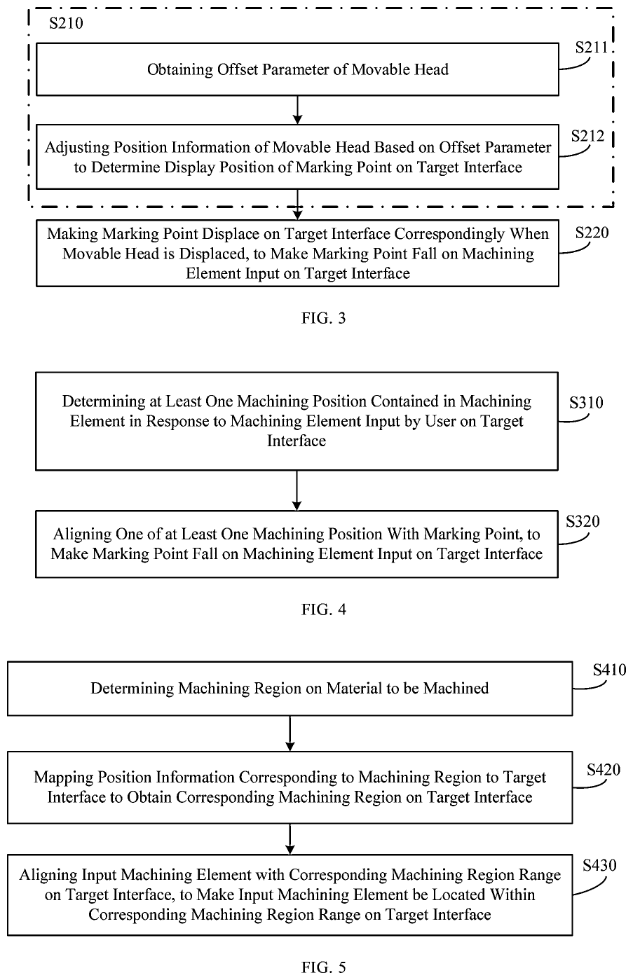

Referring to FIG. 3, FIG. 3 is a flowchart of a method for positioning the movable head according to another embodiment of the present disclosure, in this embodiment, before displaying the marking point on the target interface, the method further includes:

Step S211, obtaining an offset parameter of the movable head;

Step S212, adjusting the position information of the movable head based on the offset parameter to determine a display position of the marking point on the target interface.

These two steps are described in detail below.

In step S211, the offset parameters of the movable head are obtained by calling the hardware information of the computer numerical control machine, the offset parameters of the movable head include a tilt angle, an offset direction, a focal length, etc.,

In step S212, since the position information of the movable head cannot be accurately mapped on the target interface, and deviation will occur in the actual process of the mapping, it is necessary to combine the position information of the movable head with the offset parameters of the movable head, so as to accurately obtain the display the marking point on the target interface.

Exemplarily, if the first coordinate system and the second coordinate system are established in the same way, i.e., the origin, X-axis, and Y-axis in the first coordinate system mapped to the target interface correspond to the origin, X-axis, and Y-axis in the second coordinate system, respectively. If the real-time coordinate position of the movable head is (a, b), the coordinate position mapped to the target interface should also be (a, b) in the ideal situation, but due to the existence of the offset parameter of the movable head, this will lead to the coordinate position of the movable head mapped to the target interface (i.e., the display the marking point on the target interface) are not the same as the actual coordinate position of the movable head. When combined with the offset parameter of the moveable head, the coordinate of the marking point actually mapped to the target interface may be (a+3, b+4), (a, b−2), or other. The tilt angle of the moveable head affects the units of offset distance of the display the marking point on the target interface, and the offset direction of the moveable head affects the offset direction of the display the marking point on the target interface, whether the marking point of the moveable head is offset in the X-positive half-axis, the X-negative half-axis, the Y-positive half-axis, or the Y-negative half-axis is determined. Exemplarily, (a+3, b+4) indicates that the coordinate of the marking point relative to the coordinate position of the movable head is offset by 3 distance units in the X-positive half-axis and by 4 distance units in Y-positive half-axis; and (a, b−2) indicates that the coordinate of the marking point relative to the coordinate position of the movable head is not offset in the X-axis but is offset by 2 distance units in the Y-negative half-axis offset.

As can be seen from the above, the present embodiment combines the real-time coordinate position of the movable head with the offset parameter of the movable head, which can realize accurate position mapping, and the display the marking point obtained on the target interface will be more accurate.

Referring to FIG. 4, FIG. 4 is a flowchart of a method for positioning the movable head according to another embodiment of the present disclosure, in this embodiment, after displaying the marking point on the target interface, the method further includes:

Step S310, determining at least one machining position contained in the machining element in response to the machining element input by a user on the target interface; and

Step S320, aligning one of the at least one machining position with the marking point, to make the marking point fall on the machining element input on the target interface.

These two steps are described in detail below.

In step S310, a selected machining element is input by the user on the target interface, the machining element corresponds to an operation that the user intends to perform on the material to be machined, such as an engraving pattern corresponding to pattern engraving, a cutting position corresponding to material cutting, a graphic marking corresponding to marking, etc.

Exemplarily, if the machining element is a circle, the machining positions are all on the side lines of the circle; if the machining element is a polygon, the machining positions are all on the side lines of the polygon. It should be noted that the machining element is not necessarily closed, and therefore the machining positions of the material to be machined are not closed. At least one machining position contained in the machining element is determined based on the user-selected machining element, the machining position includes a start point, an end point, or a process point for machining.

In step S320, the moveable head is moved to the at least one machining position contained in the machining element, which includes, but is not limited to, moving the moveable head by handholding the moveable head and controlling the moveable head to move by software. Since the marking point is a point obtained by mapping the position of the moveable head to the target interface, the marking point moves on the target interface following the moveable head when the moveable head moves, such that the marking point coincides with one of the at least one machining position. In addition, it is also possible to align the marking point with one of the at least one machining position by dragging the marking point on the target interface directly by the software, so that the marking point falls on the machining element input on the target interface, and the marking point can be used as the start point of machining.

As an exemplary embodiment, the start point of machining may be determined by the user triggering an operation such as clicking in the machining path displayed on the target interface, or determined based on a preset way, for example, when the machining path is a polygon, a corner point of the machining path may be used as the start point of machining, or for example, when the machining path is a circle, a random point in the machining path may be used as the start point of machining, for example, if the machining path is non-closed, the end point of the non-closed machining path can also be used as the start point of machining, thereby effectively avoiding back and forth movement of the movable head and saving machining time of the laser, which is not limited herein.

As can be seen from the above, the present embodiment aligns the marking point with the determined machining position, which can be directly machined after receiving the laser machining request, eliminating the process of aligning after receiving laser machining request, and improving the efficiency of the laser machining.

In an exemplary embodiment, before the marking point falls on the machining element input on the target interface, the method further includes:
determining a position of the movable head in a machining plane of the computer numerical control machine based on light spots emitted by the movable head.

According to an embodiment of the present disclosure, the light spot emitted by the movable head is different from the laser light emitted by the movable head when the movable head performs laser machining, the light spot is used to visualize the position of the movable head and the laser light is used to machine including, but not limited to, such as cutting, welding, surface treatments, perforation, marking, ruling, and fine-tuning, etc.

As can be seen above, at the user perception level, the user can know the position of the movable head through the light spot, optionally for visualization during machining.

Referring to FIG. 5, FIG. 5 is a flowchart of a method for positioning the movable head according to another embodiment of the present disclosure, in this embodiment, the method further includes:

Step S410, determining a machining region on the material to be machined;

Step S420, mapping position information of the machining region to the target interface to obtain a corresponding machining region on the target interface; and

Step S430, aligning an input machining element with the corresponding machining region range on the target interface, to make the input machining element be located within the corresponding machining region range on the target interface.

These three steps are described in detail below.

In step S410, a machining region is determined on the material to be machined according to the machining demand, it is understood that the machining region is a region on an object to be machined that needs to be machined. The machining region can be the entire object to be machined or a small range on the object to be machined. The machining demand includes the machining position, a size of the area to be machined, etc. Exemplarily, if a pattern is desired to be machined in a centered position of the material to be machined, the machining region is determined based on a region needed to be machined with a pattern in this centered position. If the entire material to be machined is desired to be machined, the entire material to be machined is used as the machining region.

In step S420, the coordinate positions of the closed edge line of the machining region are mapped on the target interface, to obtain the coordinate positions of the closed edge line mapped on the target interface. By generating the corresponding closed edge line on the target interface, the range of coordinate positions within the closed edge line on the target interface is the corresponding machining region range on the target interface, which can facilitate the user to intuitively preview the machining region.

In step S430, the movement of the machining element may be triggered in response to the user's dragging operation on the target interface, or may be automatically triggered by the software based on the corresponding machining region range and the marking point on the target interface, which is not limited herein. After the machining element is moved to the corresponding machining region range on the target interface, the machining element can also be rotated, translated, etc. to accurately move the machining position of the movable head, so as to enhance the user's interactive experience.

As can be seen from the above, this embodiment can effectively prevent the laser machining of the movable head from exceeding the preset machining region by aligning the input machining element with the corresponding machining region range on the target interface, which can optionally enhance the safety of laser machining, and also facilitate the user to preview the machining region intuitively, so as to enhance the user's machining experience.

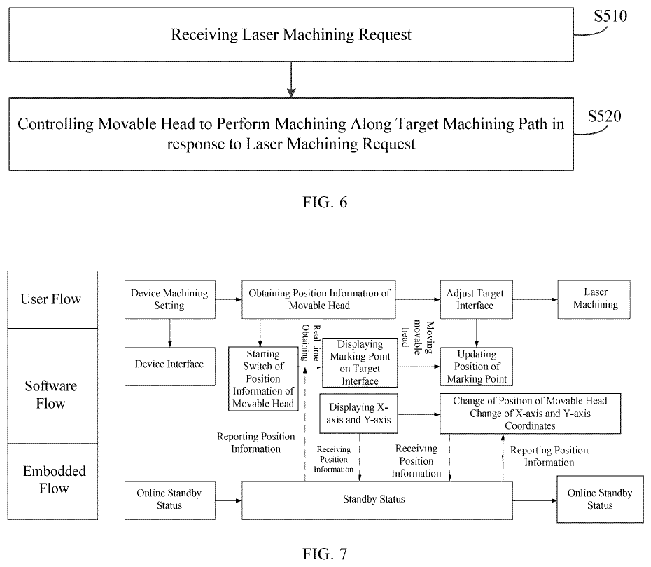

Referring to FIG. 6, FIG. 6 is a flowchart of a method for positioning a movable head according to another embodiment of the present disclosure, in this embodiment, after the marking point falls on the machining element inputted on the target interface, the method further includes:

Step S510, receiving a laser machining request; and

Step S520, controlling the movable head to machine along a target machining path in response to the laser machining request.

These two steps are described in detail below.

In step S510, a communication protocol between the software and the movable head is utilized to realize receiving a laser machining request sent by the software, the laser machining request includes parameters such as a preset machining path, a machining rate, and a laser power.

In step S520, in response to the received laser machining request, the movable head starts machining from the real-time coordinate position where it is currently located, and the movable head machines along the target machining path based on the machining rate and laser power and other requirements in the laser machining request.

As can be seen from the above, the present embodiment realizes that after the machining position is aligned with the marking point, laser machining can be performed directly without the need to position the movable head, thereby improving the efficiency of the laser machining.

In an exemplary embodiment, making the marking point displace on the target interface correspondingly when the movable head is displaced, the method further includes:
making the marking point displace on the target interface correspondingly at preset time intervals when the movable head is displaced.

According to an embodiment of the present disclosure, the time intervals may be preset, and the marking point will be correspondingly displaced according to the preset time intervals when the movable head is displaced, instead of being displaced in real time, to reduce the amount of computer operations.

Exemplarily, the preset time interval may be 1s, and the marking point is correspondingly displaced at every second when the movable head is displaced.

The following is an example of FIG. 7 to illustrate the process of positioning the movable head. Referring to FIG. 7, FIG. 7 is a flowchart of positioning the movable head according to an embodiment of the present disclosure.

The machining settings are made in the software, the desired machining elements are set, and the machining rate, laser power, etc. are adjusted. Subsequently, when the position switch of the movable head is turned on, the movable head reports position information to the software, which receives the position information of the movable head, and reads in real time the coordinate position (i.e., the X and Y axis coordinates of the marking point displayed in the second coordinate system) of the movable head mapped to the target interface at this time. When the movable head moves, the movable head will also report the position information to the software in real time, and after the software receives the position information, the coordinate of the marking point mapped on the target interface will also change with the movement of the movable head. After the movable head is moved to determine the coordinate of the marking point, the target interface (i.e., dragging the machining element to make one machining position contained in the machining element align with the marking point) is adjusted, subsequent machining operations are performed after the alignment is completed. Moreover, the movable head is in an on-line standby state when the machining setting is performed on the device, and is in a standby state when the position of the movable head is read and adjusted, and the movable head will also be in an online standby state during the subsequent operation. It is worth stating that the movable head does not emit light when the position of the movable head is read and adjusted in the embodiment of the present disclosure, and the laser light is emitted only when the movable head performs a laser machining operation.

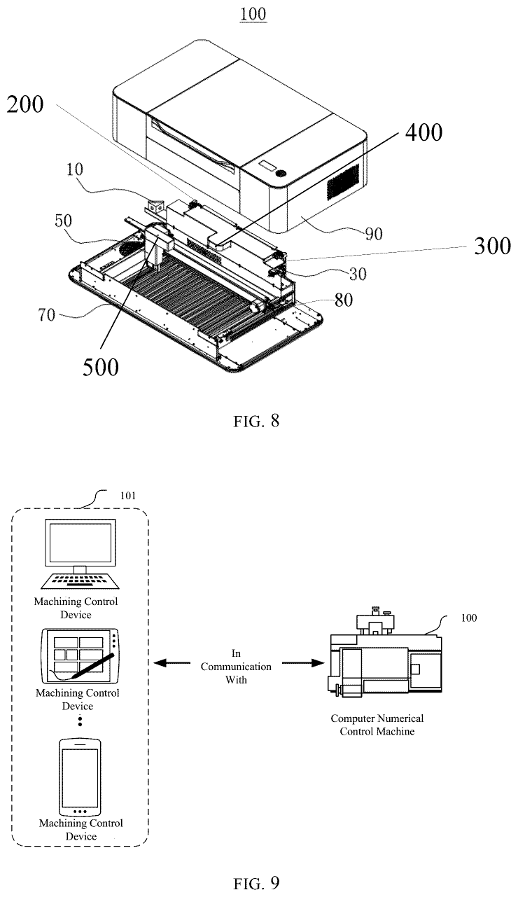

FIG. 8 is a hardware structure diagram of the computer numerical control machine 100 according to an embodiment of the present disclosure. In one embodiment, the present disclosure also provides a computer numerical control machine 100, which includes: a slide rail 80, a movable laser head 50, a communication component 200 and a controller 300. The movable laser head 50 is slidably provided on the slide rail; a communication component 200, the communication component is used to receive a computer numerical control machine 100 according to any of the above the steps of the method of any one of the above; the controller controls the movable head 50 to move on the slide rail 80 to machine the surface of the machined material based on at least the limitation region and the prompt information.

In one embodiment, as shown in FIG. 8, the computer numerical control machine 100 includes a housing, a movable laser head 50, a laser tube 30, a close shot camera 500, and a long shot camera 400. The housing includes an upper housing 90 and a bottom housing 70. The close shot camera is provided on the laser head 50. The computer numerical control machine 100 includes cameras, i.e. including but not limited to a long shot camera 400 for capturing a panoramic processing view of the inner space of the housing, and the aforementioned close shot camera, the moveable close shot camera will perform the moving and capturing. The moveable head may include the laser head 50.

In one embodiment, the laser may be generated by the laser head 50, and in another embodiment, the laser light source may be generated by other components such as a laser tube 30 of a carbon dioxide laser tube and passes through a reflector 10 into the laser exit device, and finally exits after passing through the laser head 50 for machining of the workpiece.

In an embodiment, the reflector 10 is provided between the laser head 50 and the laser tube 30, and the laser generated by the laser tube 30 passes through the reflector 10 and is reflected to the laser head 50 and then ejected after reflection, focusing and the like to process the workpiece.

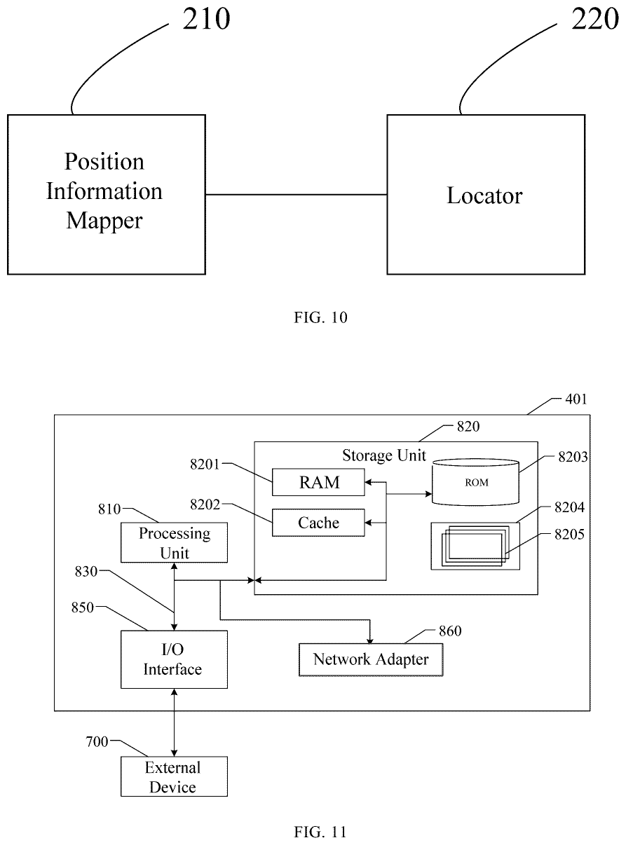

In one embodiment, the housing of the computer numerical control machine 100, i.e., the upper housing 90 and the bottom housing 70 as shown in FIG. 10, together enclose to form an internal space that can accommodate the machining object, and the upper housing 90 and the bottom housing 70 may be removably connected or fixedly connected, or the upper housing 90 and the bottom housing 70 are both of one-piece molding structure. To implement laser machining, the internal space is provided with a laser head 50, a laser tube 30 as a light source, and a close shot camera, and the laser head 50 and the close shot camera are slid by a configured rail device.

In an embodiment, the upper housing 90 is further provided with a rotatable cover plate, and an operator can open the interior space by opening or closing the cover plate to put in or take out a workpiece. The cover plate may be a blocking member that can be opened or closed as described.

Through the blocking and/or filtering effect of the upper housing 90 and the bottom housing 70, it is possible to prevent the laser head 50 from damaging the operator due to laser spillage during operation.

Exemplarily, in an embodiment, a rail device may also be provided in the interior space, and the laser head 50 is mounted on the rail device. The rail device can be X, Y axis guide, X, Y axis guide can be used, such as linear guide, or optical axis and roller with sliding guide, etc., only the laser head 50 can be driven to move in the X, Y axis for machining, the laser head 50 can also be provided with a moving track in Z axis for moving to focus before machining and/or when machining in the Z axis.

FIG. 9 is a hardware structure diagram of a machining system according to an embodiment of the present disclosure. In an embodiment, as shown in FIG. 9, the machining system includes: a computer numerical control machine 100 includes a communication component, a controller, a slide rail 80 and a movable head, the movable head is slidably provided on the slide rail 80;
a machining control device 101 in communication with the computer numerical control machine 100, in practice, the machining control device 101 includes, but is not limited to, a computer, a tablet, a cell phone, etc.; the machining control device is configured to execute a method for positioning a movable head, wherein the movable head is configured to emit a laser, the method includes:
displaying a marking point on a target interface in response to a request for obtaining position information of the movable head; wherein the marking point characterizes a coordinate position of the movable head mapped to the target interface; and
making the marking point displace on the target interface correspondingly when the movable head is displaced, to make the marking point fall on a machining element input on the target interface.

Referring to FIG. 10, according to an embodiment of the present disclosure, FIG. 10 provides an apparatus for positioning a movable head, which is provided with the movable head, the movable head is configured to emit a laser light, and further includes a position information mapper 210 and a locator 220.

The position information mapper 210 is configured to display a marking point on a target interface in response to a request for obtaining position information of the movable head; the marking point characterizes a coordinate position of the movable head mapped to the target interface.

The locator 220 is configured to make the marking point displace on the target interface correspondingly when the movable head is displaced, to make the marking point fall on a machining element input on the target interface.

In another exemplary embodiment, the position information mapper 210 further includes an offset parameter obtainer 211 and a position adjuster 212.

The offset parameter obtainer 211 is configured to obtaining an offset parameter of the movable head.

The position adjuster 212 is configured to adjust the position information of the movable head based on the offset parameter to determine a display position of the marking point on the target interface.

In another exemplary embodiment, the apparatus for positioning the movable head further includes a machining position determiner 310 and a position aligner 320.

The machining position determiner 310 is configured to determine at least one machining position contained in the machining element in response to the machining element input by a user on the target interface.

The position aligner 320 is configured to align one of the at least one machining position with the marking point, to make the marking point fall on the machining element input on the target interface.

In another exemplary embodiment, the apparatus for positioning the movable head further includes a machining region determiner 410, a machining region mapper 420, and a machining path aligner 430.

The machining region determiner 410 is configured to determine a machining region on the material to be machined.

The machining region mapper 420 is configured to map position information of the machining region to the target interface to obtain a corresponding machining region on the target interface.

The machining path aligner 430 is configured to align an input machining element with the corresponding machining region range on the target interface, to make the input machining element be located within the corresponding machining region range on the target interface.

In another exemplary embodiment, the apparatus for positioning the movable head further includes a machining requester 510 and a machining processor 520.

The machining requester 510 is configured to receive a laser machining request.

The machining processor 520 is configured to control the movable head to machine along a target machining path in response to the laser machining request.

In another exemplary embodiment, the apparatus for positioning the movable head further includes a timing displacer 610.

The timing displacer 610 is configured to make the marking point displace on the target interface correspondingly at preset time intervals when the movable head is displaced.

It is to be noted that the apparatus for positioning the movable head provided in the above embodiment and the method for positioning the movable head provided in the above embodiment belong to the same idea, in which the specific ways in which the various modules and units perform operations have been described in detail in the method embodiment, which will not be repeated herein.

The present disclosure also provides a computer numerical control machine, which includes: a slide rail; a movable head slidably provided on the slide rail; a communication component, for receiving a marking point obtained by any one of method as mentioned above; and a controller, for controlling a movement of the movable head on the slide rail to machine a surface of machining material based on the marking point.

In another exemplary embodiment, the method of positioning a movable head of an embodiment of the present disclosure may be realized by the device for positioning a movable head of FIG. 11. Referring to FIG. 11, a device for positioning a movable head according to embodiments of the present disclosure is described. The device for positioning the movable head shown in FIG. 11 is merely an example and should not bring about any limitation on the functions and scope of use of the embodiments of the present disclosure.

As shown in FIG. 11, the device for positioning the movable head is represented in the form of a general-purpose computing device. Components of the device for positioning the movable head may include, but are not limited to, the at least one processing unit 810 described above, the at least one storage unit 820 described above, and a bus 830 connecting the different system components, including the storage unit 820 and the processing unit 810.

The storage unit stores program code, and the program code may be executed by the processing unit 810, such that the processing unit 810 performs the steps described in the description section of the exemplary method described above in this specification according to various exemplary embodiments of the present disclosure. For example, the processing unit 810 may perform various steps as shown in FIG. 2.

The storage unit 820 may include a readable medium in the form of a volatile storage unit, such as a random access memory (RAM) 8201 and/or a cache memory 8202, and may also include a read-only memory (ROM) 8203.

The storage unit 820 may also include a program/utility 8204 having a set (at least one) of program modules 8205, such program modules 8205 include, but not limited to: an operation system, one or more applications, other program modules, and program data, each of these examples or some combination may include an implementation of a network environment.

The bus 830 may be a vesa local bus that represents one or more of several types of bus structures, including a memory cell bus or memory cell controller, a peripheral bus, a graphics acceleration port, a processing unit, or a local region bus using any of the multiple bus structures.

The device for positioning the movable head may also communicate with one or more external devices 700 (e.g., keyboards, pointing devices, Bluetooth devices, etc.), may also communicate with one or more devices that enable a user to interact with the device for positioning the movable head, and/or may communicate with any device (e.g., routers, modems, etc.) that enables the device for positioning the movable head to communicate with one or more other computing devices. Such communication may be performed via an input/output (I/O) interface 850. And, the device for positioning the movable head may also communicate with one or more networks (e.g., local area networks (LANs), wide area networks (WANs), and/or public networks, such as the Internet) via a network adapter 860. As shown, the network adapter 860 communicates with other modules of the device for positioning the movable head via the bus 830. It should be appreciated that, although not shown in the figures, other hardware and/or software modules may be used in conjunction with the device for positioning the movable head, including, but not limited to: microcode, device drivers, redundant processing units, external disk drive arrays, redundant array of independent disks (RAID) systems, tape drives, and data backup storage systems, etc.

By the above description of the implementations, it is readily understood by those skilled in the art that the example implementations described herein can be implemented by software or by software in combination with the necessary hardware. Thus, the technical solution according to the presently disclosed embodiments may be embodied in the form of a software product that may be stored in a non-volatile storage medium (which may be a compact disc read-only memory (CD-ROM), a USB flash drive, a movable hard disk, etc.) or on a network, and that includes a number of instructions to cause a computing device (which may be a personal computer, a server, a terminal device, or a network device, etc.) to perform a method according to the presently disclosed embodiments.

In exemplary embodiments of the present disclosure, there is also provided a computer program medium, on which computer-readable instructions is stored, the computer-readable instructions, when are executed by a processor of the computer, cause the computer to perform the method described in the above method embodiment section.

According to an embodiment of the present disclosure, there is also provided a program product for implementing the method in the above method embodiments, which may employ a portable CD-ROM and include program code, and which may be run on an end device, such as a personal computer. However, the program product of the present disclosure is not limited thereto, herein, the readable storage medium may be any tangible medium that contains or stores a program that may be used by or in combination with an instruction execution system, apparatus, or device.

The program product may employ any combination of one or more readable medium. The readable medium may be a readable signal medium or a readable storage medium. The readable storage medium may be, for example, but is not limited to, a system, apparatus or device that is electrical, magnetic, optical, electromagnetic, infrared, or semiconducting, or any combination of the above. More specific examples of readable storage medium (a non-exhaustive list) include: an electrical connection having one or more wires, a portable disk, a hard disk, a RAM, a ROM, an erasable programmable read-only memory (EPROM or flash memory), a fiber optic, a portable CD-ROM, an optical storage device, a magnetic storage device, or any suitable combination of the foregoing.

The computer readable signal medium may include a data signal propagated in baseband or as member of a carrier carrying readable program code. Such propagated data signals may take a variety of forms, including, but not limited to, electromagnetic signals, optical signals, or any suitable combination of the foregoing. The readable signal medium may also be any readable medium other than a readable storage medium that sends, propagates, or transmits a program for use by, or in conjunction with, an instruction execution system, apparatus, or device.

The program code contained on the readable medium may be transmitted using any suitable medium including, but not limited to, wireless, wired, fiber optic cable, RF, etc., or any suitable combination of the foregoing.

Program code for performing the operations of the present disclosure may be written in any combination of one or more programming languages, including object-oriented programming languages, such as Java, C++, etc., and conventional procedural programming languages, such as the “C” language or similar programming languages. The program code may be executed entirely on the user computing device, partially on the user device, as a stand-alone software package, partially on the user computing device and partially on a remote computing device, or entirely on a remote computing device or server. In situations involving a remote computing device, the remote computing device may be connected to the user computing device via any kind of network, including a LAN or a WAN, or, may be connected to an external computing device (e.g., by utilizing an Internet Service Provider to connect via the Internet).

It should be noted that although a number of modules or units of the device for action execution are mentioned in the detailed description above, this division is not mandatory. Indeed, according to embodiments of the present disclosure, the features and functions of two or more modules or units described above may be specified in a single module or unit. Conversely, the features and functions of one module or unit described above may be divided to be materialized by more than one module or unit.

Furthermore, although the various steps of the method in the present disclosure are described in the accompanying drawings in a particular order, it is not required or implied that the steps must be performed in that particular order or that all of the steps shown must be performed in order to achieve the desired result. Additional or alternatively, certain steps may be omitted, a plurality of steps may be combined to be performed as a single step, and/or a single step may be broken down to be performed as a plurality of steps, etc.

By the above description of the embodiments, it is readily understood by those skilled in the art that the embodiments described herein may be implemented by software or by software in combination with the necessary hardware. Thus, the technical solution according to the presently disclosed embodiments may be embodied in the form of a software product that may be stored in a non-volatile storage medium (which may be a CD-ROM, a USB flash drive, a movable hard disk, etc.) or on a network, and that includes a number of instructions to cause a computing device (which may be a personal computer, a server, a mobile terminal, or a network device, etc.) to perform the method according to the presently disclosed embodiments.

Other embodiments of the present disclosure will readily come to mind to those skilled in the art upon consideration of the specification and practice of the invention disclosed herein. The present disclosure is intended to cover any variations, uses, or adaptations of the present disclosure that follow the general principles of the present disclosure and include common knowledge or customary technical means in the art not disclosed herein. The specification and embodiments are to be regarded as exemplary only, and the true scope and spirit of the present disclosure is indicated by the appended claims.

What is claimed is:

1. A method for positioning a movable head, wherein the movable head is configured to emit a laser, wherein the method comprises:
displaying a marking point on a target interface in response to a request for obtaining position information of the movable head, wherein the marking point characterizes a coordinate position of the movable head mapped to the target interface; and
making the marking point displace on the target interface correspondingly when the movable head is displaced, to make the marking point fall on a machining element input on the target interface.

2. The method according to claim 1, wherein before displaying the marking point on the target interface, the method further comprises:
obtaining an offset parameter of the movable head; and
adjusting the position information of the movable head based on the offset parameter to determine a display the marking point on the target interface.

3. The method according to claim 1, wherein after displaying the marking point on the target interface, the method further comprises:
determining at least one machining position contained in the machining element in response to the machining element input by a user on the target interface; and
aligning one of the at least one machining position with the marking point, to make the marking point fall on the machining element input on the target interface.

4. The method according to claim 1, wherein before the marking point falls on the machining element input on the target interface, the method further comprises:
determining a position of the movable head in a machining plane of a computer numerical control machine based on light spots emitted by the movable head.

5. The method according to claim 3, further comprising:
determining a machining region on a material to be machined;
mapping position information of the machining region to the target interface to obtain a corresponding machining region range on the target interface; and
aligning an input machining element with the corresponding machining region range on the target interface, to make the input machining element be located within the corresponding machining region range on the target interface.

6. The method according to claim 5, wherein after the marking point falls on the input machining element on the target interface, the method further comprises:
receiving a laser machining request; and
controlling the movable head to machine along a target machining path in response to the laser machining request.

7. The method according to claim 1, wherein making the marking point displace on the target interface correspondingly when the movable head is displaced, the method further comprises:
making the marking point displace on the target interface correspondingly at preset time intervals when the movable head is displaced.

8. The method according to claim 1, wherein a switch button is provided on a target page, the request for obtaining the position information of the movable head is issued when the switch button is clicked.

9. The method according to claim 4, wherein a first coordinate system is pre-established in the machining plane of the computer numerical control machine, and wherein the position information of the movable head comprises horizontal and vertical coordinates of the light spot emitted by the movable head under the first coordinate system.

10. The method according to claim 9, wherein a second coordinate system is pre-established on a target page, and displaying the marking point on the target page in response to the request for obtaining the position information of the movable head comprises:
converting the position information of the movable head into an electrical signal;
converting the electrical signal into a coordinate position under the second coordinate system; and
after determining the coordinate position of the position information of the movable head under the second coordinate system, displaying the marking point at the coordinate position on the target page to obtain the marking point corresponding to the movable head on the target page.

11. A computer program medium, on which computer-readable instructions are stored, wherein the computer-readable instructions, when executed by a processor of a computer, cause the computer to perform the method of claim 1.

12. A computer numerical control machine, comprising:
a slide rail;
a movable head, slidably provided on the slide rail;
a communication component, for receiving a marking point obtained by a method for positioning the movable head; and
a controller, for controlling a movement of the movable head on the slide rail to machine a surface of machining material based on the marking point;
wherein the method for positioning the movable head comprises:
displaying the marking point on a target interface in response to a request for obtaining position information of the movable head, the marking point characterizes a coordinate position of the movable head mapped to the target interface; and
making the marking point displace on the target interface correspondingly when the movable head is displaced, to make the marking point fall on a machining element input on the target interface.

13. The computer numerical control machine according to claim 12, wherein before displaying the marking point on the target interface, the method further comprises:
obtaining an offset parameter of the movable head; and
adjusting the position information of the movable head based on the offset parameter to determine a display the marking point on the target interface.

14. The computer numerical control machine according to claim 12 wherein after displaying the marking point on the target interface, the method further comprises:
determining at least one machining position contained in the machining element in response to the machining element input by a user on the target interface; and
aligning one of the at least one machining position with the marking point, to make the marking point fall on the machining element input on the target interface.

15. The computer numerical control machine according to claim 12, wherein before the marking point falls on the machining element input on the target interface, the method further comprises:
determining a position of the movable head in a machining plane of the computer numerical control machine based on light spots emitted by the movable head.

16. The computer numerical control machine according to claim 14, further comprising:
determining a machining region on the material to be machined;
mapping position information of the machining region to the target interface to obtain a corresponding machining region range on the target interface; and
aligning an input machining element with the corresponding machining region range on the target interface, to make the input machining element be located within the corresponding machining region range on the target interface.

17. The computer numerical control machine according to claim 16, wherein after the marking point falls on the input machining element on the target interface, the method further comprises:
receiving a laser machining request; and
controlling the movable head to machine along a target machining path in response to the laser machining request.

18. The computer numerical control machine according to claim 15, wherein a first coordinate system is pre-established in the machining plane of the computer numerical control machine, and wherein the position information of the movable head comprises horizontal and vertical coordinates of the light spot emitted by the movable head under the first coordinate system.

19. The computer numerical control machine according to claim 18, wherein a second coordinate system is pre-established on a target page, and displaying the marking point on the target page in response to the request for obtaining the position information of the movable head comprises:
converting the position information of the movable head into an electrical signal;
converting the electrical signal into a coordinate position under the second coordinate system; and
after determining the coordinate position of the position information of the movable head under the second coordinate system, displaying the marking point at the coordinate position on the target page to obtain the marking point corresponding to the movable head on the target page.

20. A machining system, comprising:
a computer numerical control machine, comprising a communication component, a controller, a slide rail and a movable head, wherein the movable head is slidably provided on the slide rail;
a machining control device in communication with the computer numerical control machine; wherein the machining control device is configured to execute a method for positioning the movable head, wherein the movable head is configured to emit a laser,
wherein the method comprises:
displaying a marking point on a target interface in response to a request for obtaining position information of the movable head; wherein the marking point characterizes a coordinate position of the movable head mapped to the target interface; and
making the marking point displace on the target interface correspondingly when the movable head is displaced, to make the marking point fall on a machining element input on the target interface.
